(19) United States
(12) Patent Application Publication
(10) Pub. No.: US 2015/0133078 A1
(43) Pub. Date: May 14, 2015

(54) METHOD AND APPARATUS FOR COST-SAVING TELEPHONE SERVICE

(71) Applicant: Telecom Technology Center, New Taipei City (TW)

(72) Inventors: Shouder Chen, New Taipei City (TW); Hsiu-Tse Chen, New Taipei City (TW)

(21) Appl. No.: 14/506,692

(22) Filed: Oct. 6, 2014

(30) Foreign Application Priority Data
Nov. 12, 2013 (TW) 102141002

(51) Int. Cl. H04M 15/00; H04M 7/00; H04W 4/16; H04M 17/00

(52) U.S. Cl. CPC H04M 15/8083; H04M 15/09; H04M 15/8228; H04M 17/204; H04M 7/0006; H04W 4/16
USPC 455/406

(57) ABSTRACT

The present invention provides a method for a cost-saving telephone service, comprising: receiving a request for telephoning a third party client device from a communication resources using device, wherein the communication resources using device and the third party client device are connected to a first and a second telephone service networks respectively; selecting a communication resources providing device from a plurality of client devices registered to the cost-saving telephone service and connected to the second telephone service network; and having the communication resources providing device telephone the third party client device through the second telephone service network such that the communication resources using device communicates with the third party client device via the communication resources providing device.

### CROSS-REFERENCE TO RELATED APPLICATION

This application claims the priority benefit of Taiwan application serial no. 102141002, filed on Nov. 12, 2013. The entirety of the above-mentioned patent application is hereby incorporated by reference herein and made a part of this specification.

### BACKGROUND

1. Technical Field

The invention relates to a method and an apparatus for a telephone service, and particularly relates to a method and an apparatus for a cost-saving telephone service.

2. Related Art

Along with development of wireless communication technology and a development trend of miniaturization of electronic apparatuses, smart phones are greatly popularised, and become a mainstream of current mobile phones. A user can use the smart phone to connect a data network and a telephone service network at any time anywhere. Along with progress and popularisation of the wireless communication technology, although a phone call charge rate of the mobile phones has a declining trend year by year, various telecommunication practitioners still provide various promotional schemes for their long-term clients. However, the charging rate of phone calls between the telecommunication service providers (an inter-network charge rate) is still high. Therefore, various cost-saving communication software and services are vigorously developed, such as “Skype” or “Line”. The common concept among such type of software is to provide a free or low-cost telephone service based on a characteristic that the electronic apparatus or the smart phone is connected to the data network.

Taking the software “Line” as an example, such type of communication software and service could be exemplarily characterized by FIG. 1. In a communication network 100, a smart phone 101 and a smart phone 102 are all installed with such communication software, and are registered to such service. During registration, client devices (e.g., the smart phones) provide telephone numbers thereof to the service. The smart phone 101 and the smart phone 102 are connected to a server 104 providing such communication service through a data network 103 (the Internet). In case that the users of the smart phone 101 and the smart phone 102 know existence of each other and agree a mutual communication there between (add each other as friends), the users of the smart phone 101 and the smart phone 102 can communicate with each other through the data network 103 and the server 104, and the communication method includes a voice service. In this way, even if the smart phone 101 and the smart phone 102 are respectively connected to telephone service networks of different telecommunication service providers, the users of the smart phone 101 or the smart phone 102 can communicate with each other without making an expensive inter-network phone call.

In the aforementioned example, the smart phone 101 and the smart phone 102 are all required to install the same communication software and required to register on the same communication service; otherwise the communication or phone call between the smart phone 101 and the smart phone 102 cannot be implemented. However, the software “Skype” not only provides the communication method of the aforementioned example, but also integrates Type II Telecommunications services, i.e. the user can make cost-saving phone calls as long as the user registers to the communication service. As shown in FIG. 2, in a communication network 200 of FIG. 2, a smart phone 201 registers to a cost-saving telephone service (e.g., Skype). When the smart phone 201 intends to call a mobile phone 202 that does not register on the cost-saving telephone service, where the mobile phone 202 is connected to a telephone service network 205, the smart phone 201 is connected to a server 204A providing such communication service through a data network 203 (the Internet), and the server 204A is connected to a machine room 204B rented by the cost-saving telephone service provider, where the machine room 204B is connected to the telephone service network 205, such that the server 204A can establish a communication connection between the smart phone 201 and the mobile phone 202 through the machine room 204B. Certainly, in such service, the cost-saving telephone service provider still charges a service fee from the user to cover the cost of renting the machine room.

In the current technique, if two terminals of the cost-saving telephone service are not registered to the same cost-saving telephone service, such as the two smart phones to be communicated with each other are not installed with the same communication software, or one terminal of the phone call is not a smart phone, or one terminal of the phone call is a telephone using public switched telephone network, the cost-saving telephone service relies on the machine room rented from the telecommunication service provider by the cost-saving telephone service provider (i.e. a Type II telecommunication service). Such system structure is lack of flexibility and has a high cost, and the service users have to cover the cost of renting the machine room. The current cost-saving telephone technique does not fully integrate resources of the data network and the telephone service networks, and does not fully exploit the characteristic of the modern smart phone capable of simultaneously connecting the data network and the telephone service network.

### SUMMARY

In order to fully integrate resources of a data network and a telephone service network, and to fully exploit a characteristic of modern smart phone capable of simultaneously connecting the data network and the telephone service network to facilitate users of a cost-saving telephone service to get a more comprehensive and low price cost-saving telephone service, the invention provides a method for a cost-saving telephone service, which includes following steps. A request for telephoning a third party client device is received from a communication resource using device, where the communication resource using device is a client device registered to the cost-saving telephone service, and is connected to a server through a data network, and the communication resource using device and the third party client device are respectively connected to a first telephone service network and a second telephone service network. A communication resource providing device is selected from a plurality of client devices registered to the cost-saving telephone service and connected to the second telephone service network, and the communication resource providing device is connected to the server through the data network. The communication resource providing device telephones the third party client device through the second telephone service network such that the communication resource using device communicates with the third party client device via the communication resource providing device.

Preferably, in the method for the cost-saving telephone service of the invention, the cost-saving telephone service has each of the client devices registered to the cost-saving telephone service provide a connected telephone number thereof and a name of a corresponding telephone service network to the cost-saving telephone service.

Preferably, in the method for the cost-saving telephone service of the invention, the cost-saving telephone service has each of the client devices registered to the cost-saving telephone service provide at least one of bandwidth data thereof and continuous positioning data thereof to the cost-saving telephone service.

Preferably, in the method for the cost-saving telephone service of the invention, the communication resource providing device is selected from the client devices registered to the cost-saving telephone service and connected to the second telephone service network according to at least one of the bandwidth data and the continuous positioning data provided by the client devices.

Preferably, in the method for the cost-saving telephone service of the invention, a user of the communication resource providing device is granted a right to actively cancel a communication between the communication resource using device and the third party client device, and the cost-saving telephone service records a call cancelling operation on a call cancelling record, and records the client device selected as the communication resource providing device in the communication.

Preferably, in the method for the cost-saving telephone service of the invention, the communication resource providing device is selected from the client devices registered to the cost-saving telephone service and connected to the second telephone service network according to the call cancelling record.

Preferably, in the method for the cost-saving telephone service of the invention, each of the client devices registered to the cost-saving telephone service is assigned with a corresponding communication service account, which is refillable to a user.

Preferably, the method for the cost-saving telephone service of the invention further includes following steps. A service fee is charged from the communication service account corresponding to the communication resource using device according to a session and a duration that the communication resource using device communicates with the third party client device via the communication resource providing device.

Preferably, the method for the cost-saving telephone service of the invention further includes following steps. A cost-saving communication service account corresponding to the communication resource providing device is refilled according to a session and a duration that the communication resource using device communicates with the third party client device via the communication resource providing device.

Preferably, in the method for the cost-saving telephone service of the invention, a charging rate being charged by the communication resource providing device is determined by a user of the client device selected as the communication resource providing device.

Preferably, in the method for the cost-saving telephone service of the invention, the communication resource providing device is selected from the client devices registered to the cost-saving telephone service and connected to the second telephone service network according to charging rates for providing communication resources that are determined by users of the client devices.

Preferably, in the method for the cost-saving telephone service of the invention, the request for telephoning the third party client device by the communication resource using device comes from a peer-to-peer connection device, and the peer-to-peer connection device is connected to the communication resource using device in a peer-to-peer manner through a wireless transmission technique.

Preferably, in the method for the cost-saving telephone service of the invention, the wireless transmission technique is one of Bluetooth, wireless fidelity, or a device-to-device communication.

The invention further provides a method for a cost-saving telephone service, which includes following steps. A request for telephoning a third party client device is proposed by a communication resource using device, where the communication resource using device is a client device registered to the cost-saving telephone service, and is connected to a server through a data network, and the communication resource using device and the third party client device are respectively connected to a first telephone service network and a second telephone service network. The communication resource using device communicates with the third party client device via a communication resource providing device, where the communication resource providing device is selected from a plurality of client devices registered to the cost-saving telephone service and connected to the second telephone service network, and the communication resource providing device is connected to the server through the data network, and the communication resource providing device telephones the third party client device through the second telephone service network.

The invention provides an apparatus for a cost-saving telephone service, which includes a server, and the server receives a request for telephoning a third party client device from a communication resource using device, where the communication resource using device is a client device registered to the cost-saving telephone service, and is connected to the server through a data network, and the communication resource using device and the third party client device are respectively connected to a first telephone service network and a second telephone service network. The server selects a communication resource providing device from a plurality of client devices registered to the cost-saving telephone service and connected to the second telephone service network, where the communication resource providing device is connected to the server through the data network. The server has the communication resource providing device telephone the third party client device through the second telephone service network such that the communication resource using device communicates with the third party client device via the communication resource providing device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a communication network, in which a server and communication software collaborate to provide a cost-saving telephone service of the conventional technique.

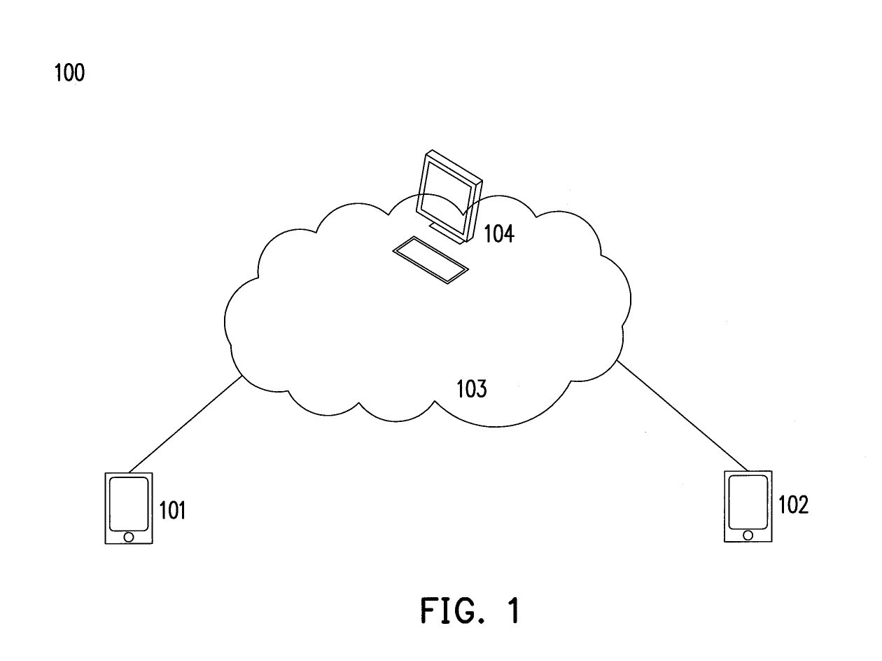

FIG. 2 is a schematic diagram of another communication network, in which a server and communication software collaborate to provide a cost-saving telephone service of the conventional technique.

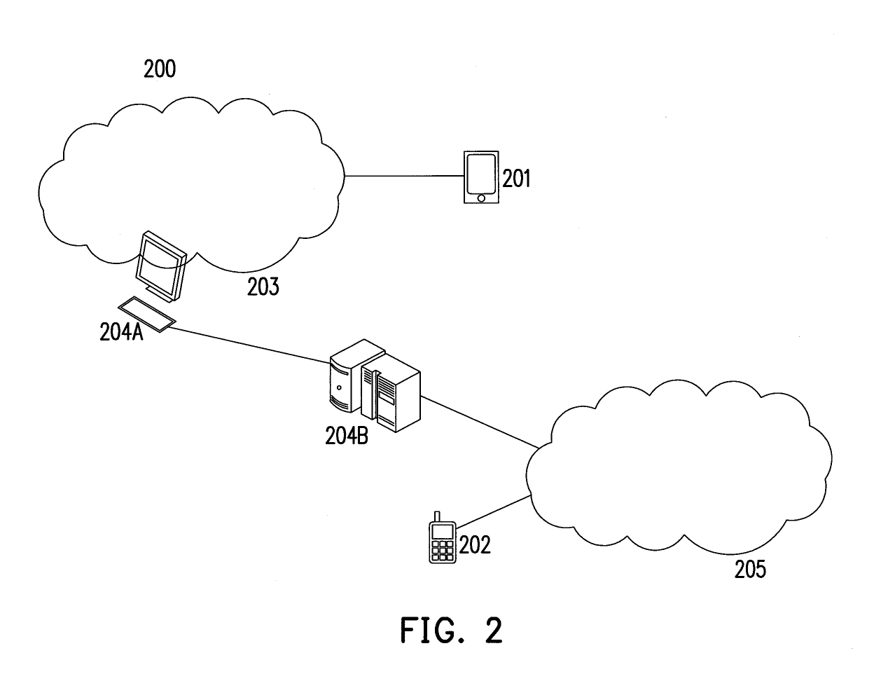

FIG. 3 is a schematic diagram of another communication network, in which a server and communication software collaborate to provide a cost-saving telephone service of a first embodiment of the invention.

FIG. 4 is a schematic diagram of another communication network, in which a server and communication software collaborate to provide a cost-saving telephone service of a second embodiment of the invention.

### DETAILED DESCRIPTION OF DISCLOSED EMBODIMENTS

Although the invention is fully described below with reference of preferred embodiments and attached drawings, it will be apparent to those skilled in the art that various modifications and variations can be made to the structure of the invention without departing from the scope or spirit of the invention. Therefore, the following description is a broad disclosure to those skilled in the art, and the content thereof is not intended to be limiting of the invention.

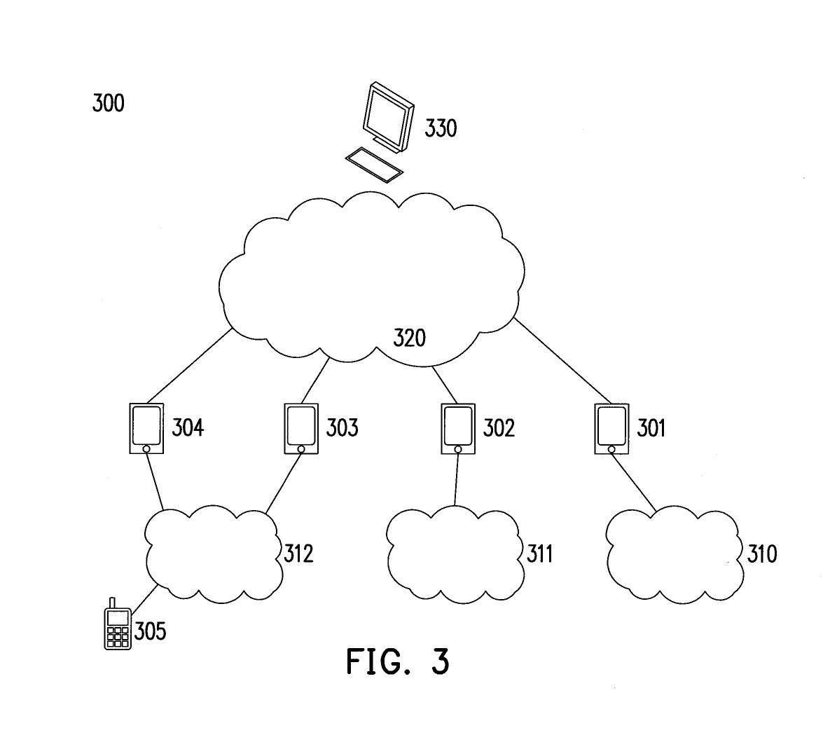

A first embodiment of the invention is shown in FIG. 3. In a communication network 300 of the present embodiment, a server 330 provides a cost-saving telephone service of the first embodiment of the invention. Smart phones 301, 302, 303 and 304 are a plurality of client devices registered to the cost-saving telephone service. Except for the smart phones, the cost-saving telephone service can also provide services to devices capable of connecting a data network, such as tablet computers, personal computers (PCs), etc. In the present embodiment, the client devices are directly or indirectly connected to the Internet 320, and are connected to the server 330 providing the cost-saving telephone service.

Generally, the client devices registered to the cost-saving telephone service are all installed with client software corresponding to such service. After installation of the client software is completed, when the client software is executed for the first time, the client device is asked to perform a registration operation. In the registration operation, the client device is asked to provide contact information. For example, a smart phone is asked to provide a connected telephone number thereof and a name of a connected telephone service network (i.e. a telephone service provider, such as AT&T, Sprint, etc.), and a tablet computer or a PC provides an e-mail account of the user. In the present embodiment, the smart phone 301 is connected to a telephone service network 310, the smart phone 302 is connected to a telephone service network 311, and the smart phones 303 and 304 are connected to a telephone service network 312.

It is assumed that the smart phones 301, 302, 303 and 304 are all in an on-line state (connected to the Internet, and execute the client software of the cost-saving telephone service) at a time point, and the user of the smart phone 301 wants to telephone a mobile phone 305 connected to the telephone service network 312, where the mobile phone 305 is not registered to the cost-saving telephone service (the mobile phone 305 may not be installed with the client software, or the mobile phone 305 may not be a smart phone), and the user of the smart phone 301 does not want to make an expensive inter-network phone call. Therefore, the smart phone 301 provides the telephone number of the mobile phone 305 to the server 330 to request the cost-saving telephone service (i.e., the user of the smart phone 301 uses the client software of the cost-saving telephone service to telephone the mobile phone 305). After the server 330 receives the request, the server 330 selects a client device from a plurality of client devices being registered to the cost-saving telephone service, on-line and connected to the telephone service network 312 to complete a connection service. In the present embodiment, the server 330 selects the smart phone 304 and makes the smart phone 304 telephone the mobile phone 305, such that the smart phone 301 is connected to the mobile phone 305 through the server 330 and the smart phone 304. In this way, resources of the Internet 320 and the telephone service network 312 are fully exploited, and the connection between the smart phone 304 and the mobile phone 305 is an intra-network communication, which may be cheap or even free.

In the present embodiment, the smart phone 301 is obviously a communication resource using device, and under a concept of “user-pays principle” the cost-saving telephone service can charge the user of the smart phone 301 according to a duration, a session, etc. that the smart phone 301 communicates with the mobile phone 305. The cost-saving telephone service can create a communication service account corresponding to a client device when the client device is registered to the cost-saving telephone service, the user can refill the communication service account, and the cost-saving telephone service can directly charge the communication service account every time the service is ended. The user may refill the communication service account through on-line payment (via credit card, third party payment, etc.) or by purchasing a prepaid card from a physical store (for example, a convenience store), and a unit of refilling or charging of the cost-saving telephone service can be a real currency unit or a virtual currency unit.

In the present embodiment, the smart phone 304 is obviously a communication resource (bandwidth) providing device, and after the communication between the smart phone 301 and the mobile phone 305 is ended, the cost-saving telephone service pays the user of the smart phone 304 according to information such as a duration, a session, etc. of the communication between the smart phone 301 and the mobile phone 305. The most direct way of the payment is to directly refill the communication service account corresponding to the smart phone 304. In a pattern of the embodiment, a charging rate being charged is the same for each of the client devices. That is, when any of the client devices registered to the cost-saving telephone service is selected as the communication resource providing device in a communication request, the charging rate charged from the cost-saving telephone service is the same (though different session still have different valuation methods). In another pattern of the embodiment, the charging rate can be determined by the user of the client device, and a reason thereof is that the cost for each of the client devices obtaining a bandwidth is different, so that the charging rate required by each client device for lending the bandwidth is different. The cost-saving telephone service has a function of assisting the client device to manage a communicating time thereof. For example, the cost-saving telephone service obtains a free intra-network communication time remained in the communication service account of a client device to help the client device determine the charging rate for lending the bandwidth. In an extreme example, if one client device has run out of the free intra-network communication time during one time period, the client device can be set to unconditionally reject lending the communication resource through the cost-saving telephone service.

In the present embodiment, after the smart phone 304 is selected as the communication resource providing device during the communication between the smart phone 301 and the mobile phone 305, the user of the smart phone 304 is granted a right to actively cancel the communication between the smart phone 301 and the mobile phone 305 (through the client software), and a reason thereof is that the user of the smart phone 304 probably wants to use the bandwidth at the same time. The server 330 records information related to the call cancelling operation, such as a duration of the communication before the call cancelling operation, the client device that cancels the communication (the communication resource providing device), etc. for reference.

In the present embodiment, the cost-saving telephone service can also collect other information of the registered client devices, such as a bandwidth of each registered client device, continuous positioning data, etc. In the cost-saving telephone service of the present embodiment, after a server (for example, the server 330) receives a communication request from a communication resource using device, the server selects a communication resource providing device from a plurality of client devices satisfying some conditions (e.g., being on-line and connected to a telephone service network the same with that of a receiver). The number the client devices satisfying the conditions is probably plural, and now the cost-saving telephone service makes a comprehensive assessment according to other information of the client devices satisfying the conditions, where the other information may include a bandwidth, a position, the historical call cancelling record, the charging rate of lending the bandwidth, etc. of each client devices.

In the aforementioned embodiment, though all of the client devices are smart phones, the cost-saving telephone service can also be provided to client devices that are not connected to the telephone service network, such as tablet computers PCs, etc. Obviously, the client device being unconnected to the telephone service network can only serve as a communication resource using device, and cannot be selected as a communication resource providing device. Moreover, for the communication between two client devices being both registered to the cost-saving telephone service, the two client devices can communicate with each other purely through the server as exemplarily shown in FIG. 3. In FIG. 3, the smart phone 301 and the smart phone 304 directly communicate with each other through the server 330 by using the bandwidth resource of the Internet.

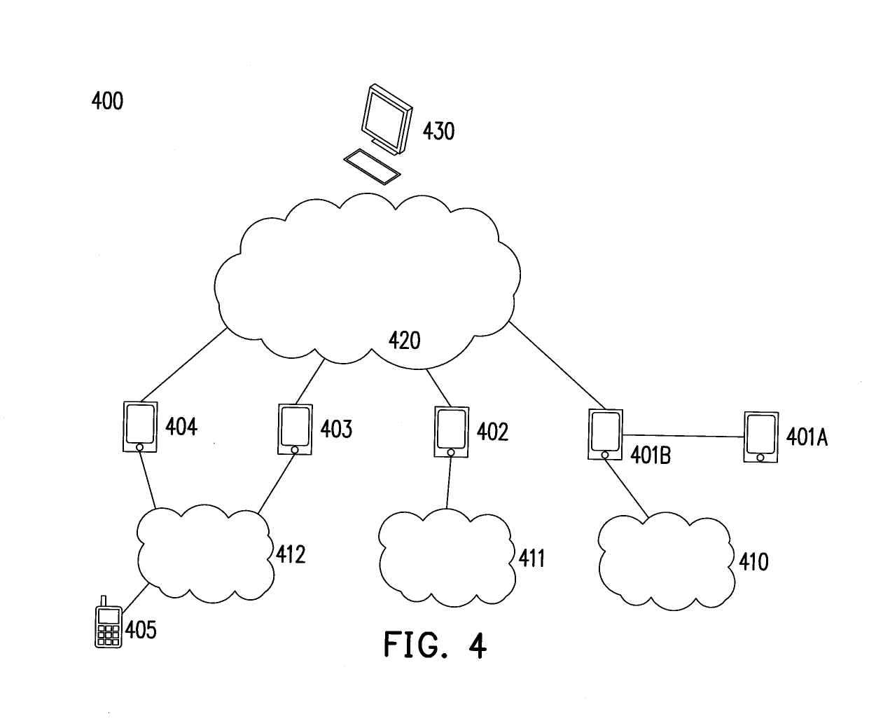

A second embodiment of the invention is shown in FIG. 4. In a communication network 400 of the present embodiment, a server 430 provides the cost-saving telephone service of the second embodiment of the invention. Smart phones 401B, 402, 403 and 404 are a plurality of client devices registered to the cost-saving telephone service, and the client devices are connected to the server 430 through the Internet 420. In the present embodiment, the server 430 can provide all of the services mentioned in the first embodiment of the invention through the client software. The smart phone 401B is connected to a telephone service network 410, the smart phone 402 is connected to a telephone service network 411, and the smart phones 403 and 404 are connected to a telephone service network 412. In the present embodiment, a smart phone 401A wants to communicate with a mobile phone 405 connected to the telephone service network 412, and the smart phone 401A can use a device-to-device (D2D) communication technique to connect to the smart phone 401B, and logs in the cost-saving telephone service of the invention through the smart phone 401B. Then, the smart phone 401A provides a request for telephoning the mobile phone 405 to the cost-saving telephone service through the smart phone 401B. After the server 430 receives the request, the server 430 selects the smart phone 404 from the client devices registered to the cost-saving telephone service and connected to the telephone service network 412, and makes the smart phone 404 make an intra-network phone call to the mobile phone 405, so as to implement the communication connection between the smart phone 401A and the mobile phone 405. In the present embodiment, not only the D2D communication technique can be used to connect the smart phone 401A and the smart phone 401B, but Bluetooth, wireless fidelity or other wireless communication techniques can also be used as well. Since the smart phone 401A logs in the cost-saving telephone service through the smart phone 401B, the server 430 authenticates whether the smart phone 401B is registered to the cost-saving telephone service. Once the authentication is positively completed and the communication request is received, the cost-saving telephone service charges a service fee from the smart phone 401B. As for the selection of the communication resource providing device of the present embodiment, the calculation of the service fee of the communication resource using device, or the charging rate charged by the communication resource providing device are all similar to the system of the first embodiment of the invention.

According to various embodiments of the invention, the method for the cost-saving telephone service fully integrates the resources of the data network and the telephone service networks without renting a machine room from a telephone service practitioner, and hence to provide inter-network and low cost telephone service.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for a cost-saving telephone service, which is performed by a server comprising:
receiving a request for telephoning a third party client device from a communication resource using device, wherein the communication resource using device is a client device registered to the cost-saving telephone service, and is connected to the server through a data network, and the communication resource using device and the third party client device are respectively connected to a first telephone service network and a second telephone service network;
selecting a communication resource providing device from a plurality of client devices registered to the cost-saving telephone service and connected to the second telephone service network, wherein the communication resource providing device is connected to the server through the data network; and
having the communication resource providing device telephone the third party client device through the second telephone service network such that the communication resource using device communicates with the third party client device via the communication resource providing device.

2. The method for the cost-saving telephone service as claimed in claim 1, wherein the cost-saving telephone service makes each of the client devices registered to the cost-saving telephone service provide a connected telephone number thereof and a name of a corresponding telephone service network to the cost-saving telephone service.

3. The method for the cost-saving telephone service as claimed in claim 1, wherein the cost-saving telephone service makes each of the client devices registered to the cost-saving telephone service provide at least one of bandwidth data thereof and continuous positioning data thereof to the cost-saving telephone service.

4. The method for the cost-saving telephone service as claimed in claim 3, wherein the step of selecting the communication resource providing device from the client devices registered to the cost-saving telephone service and connected to the second telephone service network comprising:
selecting the communication resource providing device from the client devices registered to the cost-saving telephone service and connected to the second telephone service network according to at least one of the bandwidth data and the continuous positioning data provided by the client devices.

5. The method for the cost-saving telephone service as claimed in claim 1, wherein a user of the communication resource providing device is granted a right to actively cancel a communication between the communication resource using device and the third party client device, and the cost-saving telephone service records a call cancelling operation on a call cancelling record, and records the client device selected as the communication resource providing device in the communication.

6. The method for the cost-saving telephone service as claimed in claim 5, wherein the step of selecting the communication resource providing device from the client devices registered to the cost-saving telephone service and connected to the second telephone service network comprising:
selecting the communication resource providing device from the client devices registered to the cost-saving telephone service and connected to the second telephone service network according to the call cancelling record.

7. The method for the cost-saving telephone service as claimed in claim 1, wherein each of the client devices registered to the cost-saving telephone service is assigned with a corresponding communication service account, which is refillable to a user.

8. The method for the cost-saving telephone service as claimed in claim 7, further comprising charging a service fee from the communication service account corresponding to the communication resource using device according to a session and a duration that the communication resource using device communicates with the third party client device via the communication resource providing device.

9. The method for the cost-saving telephone service as claimed in claim 7, further comprising refilling a cost-saving communication service account corresponding to the communication resource providing device according to a session and a duration that the communication resource using device communicates with the third party client device via the communication resource providing device.

10. The method for the cost-saving telephone service as claimed in claim 9, wherein a charging rate being charged by the communication resource providing device is determined by a user of the client device selected as the communication resource providing device.

11. The method for the cost-saving telephone service as claimed in claim 10, wherein the step of selecting the communication resource providing device from the client devices registered to the cost-saving telephone service and connected to the second telephone service network comprising:
selecting the communication resource providing device from the client devices registered to the cost-saving telephone service and connected to the second telephone service network according to charging rates for providing communication resources that are determined by users of the client devices.

12. The method for the cost-saving telephone service as claimed in claim 1, wherein the request for telephoning the third party client device by the communication resource using device comes from a peer-to-peer connection device, and the peer-to-peer connection device is connected to the communication resource using device in a peer-to-peer manner through a wireless transmission technique.

13. The method for the cost-saving telephone service as claimed in claim 12, wherein the wireless transmission technique is one of Bluetooth, wireless fidelity, or a device-to-device communication.

14. A method for a cost-saving telephone service, which is performed by a user, comprising:
proposing, by a communication resource using device, a request for telephoning a third party client device, wherein the communication resource using device is a client device registered to the cost-saving telephone service, and is connected to a server through a data network, and the communication resource using device and the third party client device are respectively connected to a first telephone service network and a second telephone service network; and
communicating, by the communication resource using device, with the third party client device via a communication resource providing device, wherein the communication resource providing device is selected from a plurality of client devices registered to the cost-saving telephone service and connected to the second telephone service network, and the communication resource providing device is connected to the server through the data network, and the communication resource providing device telephones the third party client device through the second telephone service network.

15. An apparatus for a cost-saving telephone service, comprising a server, wherein the server:
receives a request for telephoning a third party client device from a communication resource using device, wherein the communication resource using device is a client device registered to the cost-saving telephone service, and is connected to the server through a data network, and the communication resource using device and the third party client device are respectively connected to a first telephone service network and a second telephone service network;
selects a communication resource providing device from a plurality of client devices registered to the cost-saving telephone service and connected to the second telephone service network, wherein the communication resource providing device is connected to the server through the data network; and
has the communication resource providing device telephone the third party client device through the second telephone service network such that the communication resource using device communicates with the third party client device via the communication resource providing device.
